(19) United States
(12) Patent Application Publication
(10) Pub. No.: US 2002/0181032 A1
(43) Pub. Date: Dec. 5, 2002

(54) Image reading apparatus, program, and recording medium which can be read by computer

(75) Inventor: Hisashi Sano, Tokyo (JP)

Correspondence Address: OLIFF & BERRIDGE, PLC, P.O. BOX 19928, ALEXANDRIA, VA, 22320, US

(73) Assignee: Nikon Corporation, Tokyo (JP)

(21) Appl. No.: 10/029,185

(22) Filed: Dec. 28, 2001

(30) Foreign Application Priority Data
Jun. 4, 2001 (JP) 2001-168238

(51) Int. Cl. H04N 1/46

(52) U.S. Cl. 358/506; 358/509

(57) ABSTRACT

Based on density characteristics of a transparent film original, individual light density distributions for color resolution signals read by an imaging means can be obtained. Because of this, a color state of the transparent film original can be accurately obtained. The density characteristics which are used in a process which calculate the individual light density distributions change according to the type of transparent film original, so a color state of the transparent film original can be further accurately obtained.

### INCORPORATION BY REFERENCE

This application is based on Japanese Patent Application 2001-168238, the disclosure of which is incorporated herein by reference.

### BACKGROUND OF THE INVENTION

1. Field of the Invention

This invention relates to an image reading apparatus which reads a color image on a transparent film, such as a photographic film, as color resolution signals of a plurality of colors, a program which accomplishes signal processing by a computer with respect to color resolution signals of a plurality of colors read by the image reading apparatus, and a recording medium on which the program is recorded and which can be read by a computer.

2. Related Art

A film scanner one type of image reading apparatus which optically reads a color image of a transparent film.

A film scanner irradiates a film original by using an LED and a fluorescent tube as a light source and photoelectrically converts transmitted light of the film original by a line sensor or the like, to obtain color resolution signals of a plurality of colors. For example, when LEDs of three colors R, G, and B are used as a light source, the LEDs of three colors R, G, and B are sequentially caused to emit, and RGB signals corresponding to transmitted light of the film original with respect to the respective lights can be obtained.

The RGB signals which are thus obtained depend on the respective LED wavelength regions, and other wavelength regions are not reflected, so accurate color reproduction is not necessarily accomplished. Because of this, there is a difference between an image that results when this type of RGB signal is output by a monitor or printer, and the result of a film original that is observed using a viewer that uses a light source in which a wavelength region extends continuously over a wide range.

Therefore, in order to improve accuracy of color reproduction, a film scanner using color management is used.

In a conventional film scanner using color management, colorimetry and scanning of a chart (e.g., ANSI IT8.7) having a plurality of colors are performed in advance, and a LUT (Look Up Table) showing correlation between scan data (equivalent to a value of an RGB signal) for each color within the chart and colorimetry data is stored as a profile. Then, when a film original is scanned, it is converted based on the profile described by the scan data with respect to the film original, and the signal which is obtained as the result is supplied to a monitor or a printer via a personal computer. Because of this, accuracy of color reproduction is improved.

Additionally, in a conventional film scanner, a LUT which can convert scan data can be arranged according to characteristics of color reproduction of an output device such as a monitor or a printer, or a LUT which can convert scan data can be arranged according to a condition of a light source of a viewer. Because of this, an image substantially equivalent to a result of observance of the film original using the above-mentioned viewer or the like can be output by a monitor or a printer.

However, the number of colors on the chart is limited. In the LUT based on actual measurement of the chart, it is difficult to accomplish conversion of various scan data with respect to the film original. Because of this, with respect to colors which do not exist on the chart, a LUT must be created by using a value obtained by an interpolation method or the like, and there was a high possibility that accurate color reproduction can not be accomplished.

Furthermore, in a conventional film scanner, using this type of interpolation method or the like, it is possible to create a profile which can be applied to approximately 32,000 colors from scan data or to colorimetry data with respect to approximately 300 colors. However, even if this type of profile is used, it is impossible to cover all scan data with respect to the film original. Because of this, conversion with respect to scan data which does not exist in the profile had to be performed by an interpolation method or the like.

Furthermore, the relationship between scan data and colorimetry data with respect to a chart varies depending on the film brand and is not necessarily common to all films. Because of this, in a conventional film scanner, a chart is color-measured for each film with a different brand, and a profile needs to be created. Furthermore, in the case of colorimetry, there are films which can not use an already-existing chart, and there is a need for creating a chart with respect to this type of film.

### SUMMARY OF THE INVENTION

An object of this invention is to supply an image reading apparatus which can perform accurate color reproduction.

Another object of this invention is to accurately and easily create a table which converts a color resolution signal to a value of a predetermined chart color system.

In order to address the above-mentioned object, the image reading apparatus of this invention is provided with an imaging means, which reads a color image of a transparent film as color resolution signals of a plurality of colors, and an individual light density distribution calculation means, which calculates an individual color density distribution of the transparent film from a density characteristic of the transparent film and the color resolution signal read by the imaging means.

### BRIEF DESCRIPTION OF THE DRAWINGS

FIG. 1 is a structural diagram of a film scanner according to this invention.

FIG. 2 is an operation flowchart of a signal processor of a first embodiment.

FIG. 3 is an operation flowchart of a signal processor of a second embodiment.

FIG. 4 is an operation flowchart of a signal processor of the second embodiment.

### DETAILED DESCRIPTION OF THE PREFERRED EMBODIMENT(S)

Based on the drawings, the following explains details of embodiments of this invention.

Furthermore, in the following embodiments, an example in which this invention is applied to a film scanner is shown, but this invention is not limited to a film scanner. In the same manner, the invention can also be applied to an image reading apparatus which can read a color image of a transparent film original as color resolution signals of a plurality of colors.

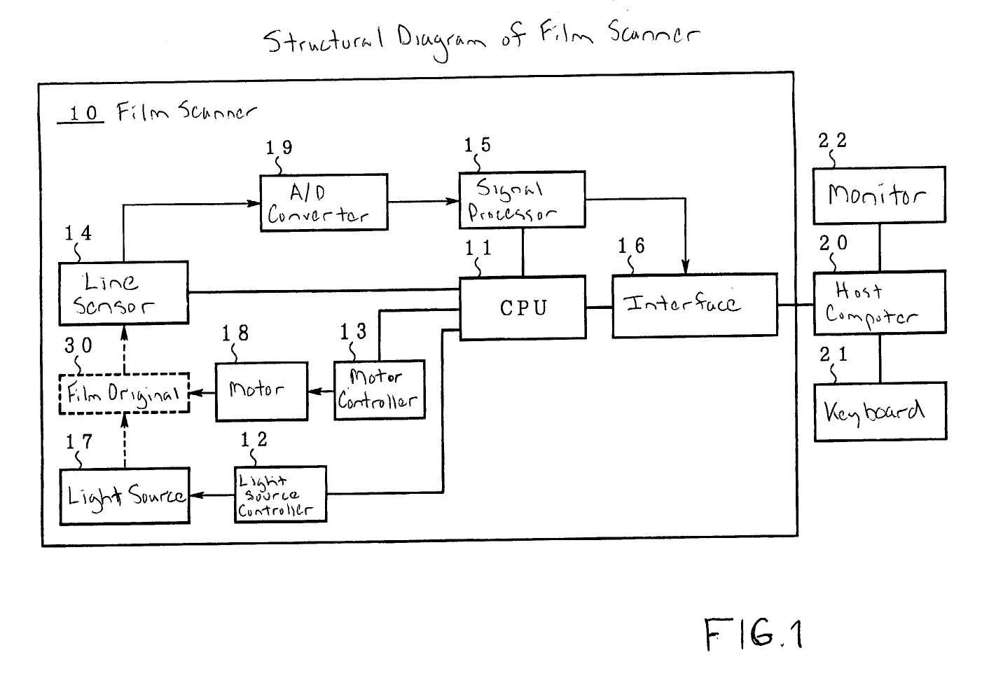

FIG. 1 is a structural diagram of a film scanner.

In FIG. 1, a film scanner 10 is provided with a CPU 11, a light source controller 12 connected to the CPU 11, a motor controller 13, a line sensor 14, a signal processor 15, an interface 16, a light source 17 connected to the light source controller 12, a motor 18 connected to the motor controller 13, and an A/D converter 19. Additionally, in FIG. 1, output of the line sensor 14 is connected to the A/D converter 19, output of the A/D converter 19 is connected to the signal processor 15, and output of the signal processor 15 is connected to the interface 16.

Furthermore, the film scanner 10 is connected to a host computer (such as a personal computer or the like) 20 via the interface 19. Additionally, a keyboard 21 as an input device is connected to the host computer 20, and a monitor 22 as an output device is connected to the host computer 20.

In this type of film scanner 10, a method of reading a film original 30 varies depending on the type of the light source 17 and the type of line sensor 14. However, in this embodiment, an example is shown in which LEDs using the three colors R, G, and B are used as the light source 17, the LEDs using the three colors R, G, and B are sequentially caused to emit, and an RGB signal is generated corresponding to light transmitted through the film original 30 with respect to each light beam.

The LEDs of the three colors R, G, and B arranged as the light source 17 are controlled by the light source controller 12, which is operated under the direction of the CPU 11, and emit light. The motor 18 is controlled by the motor controller 13 which is operated under the direction of the CPU 11, and the film original 30 is moved in a sub-scanning direction line-by-line by driving a pair of rollers, which are not depicted, which exists in a conveyance path of the film original 30.

The line sensor 14 photoelectrically converts transmitted light of the film original 30 to a signal charge and generates a RGB signal based on the signal charge.

The A/D converter 19 A/D-converts the RGB signal which is output from the line sensor 14 and supplies the signal to the signal processor 14.

The signal processor 15 performs signal processing over to the RGB signal which was thus supplied as described later.

The interface 16 supplies the RGB signal in which signal processing has been performed by the signal processor 15 to the host computer 20.

Furthermore, the RGB signal supplied to the host computer 20 is displayed on the monitor 22.

Here, in order to simplify the explanation of each embodiment, a characteristic of an individual light density distribution of a film is explained.

A film has a red photosensitive layer (cyan color layer), a green photosensitive layer (magenta color layer), and a blue photosensitive layer (yellow color layer). Target images shot under illumination by various light sources are recorded to the respective photosensitive layers as exposure amounts of R, G, and B light according to the individual light photosensitivity of each photosensitive layer. Furthermore, after developing, according to the exposure amount of R, G, and B light, color elements of cyan, magenta, and yellow appear in the respective layers. That is, the density difference of the respective color elements of cyan, magenta, and yellow appears as a color difference.

A film manufacturer provides an individual light density curve of each layer with respect to a specified color (e.g., gray) as a data sheet of each film.

If an individual light density curve of the respective layers of cyan, magenta, and yellow which are thus provided is expressed as functions dc(λ), dm(λ), dy(λ) in which a wavelength λ is variable, an individual light density distribution D(λ) of an arbitrary color can be approximated by the following equation 1. However, in equation 1, C, M, and Y are actual numbers. In the case of C=M=Y=1, D(λ) shows the individual light density distributions with respect to the above-mentioned specified color.

D(λ)=C·dc(λ)+M·dm(λ)+Y·dy(λ) Equation 1

Therefore, with respect to an arbitrary position on a developed film, if the values of three parameters C, M, and Y can be found, an individual light density distribution at the position can be obtained, and accurate color reproduction becomes possible.

The following explains the reason why the individual light density distribution of an arbitrary color can be approximated by equation 1.

For example, a state is considered in which a red photosensitive layer (cyan color layer) of the film is photosensitized at a thickness that is twice the thickness when the above-mentioned specified color is shot. In this type of state, when intensity of input light with wavelength λ1 is I0, intensity I′ of transmitted light which has passed through the red photosensitive layer (cyan color layer) can be expressed by the following equation 2.

I′=I0×10(−dc(λ1))×10(−dc(λ1))=I0×10(−2dc(λ1)) Equation 2

Additionally, the density I′ of transmitted light with respect to another wavelength λ2 can be expressed by the following equation 3.

I′=I0×10(−dc(λ2))×10(−dc(λ2)=I0×10(−2dc(λ2)) Equation 3

Therefore, when intensity of input light is I0, intensity I′ of transmitted light in the red photosensitive layer (cyan color layer) can be expressed by the following equation 4 by using wavelength λ. However, in equation 4, C is an actual number.

I′=I0×10(−Cdc(λ)) Equation 4

Furthermore, transmittance like the red photosensitive layer (cyan color layer) can be expressed as:

10(−Cdc(λ)).

Transmittance in other layers can also be expressed in the same manner. Because of this, transmittance when input light goes through all the layers can be expressed as:

10(−Cdc(λ))×10(−Mdm(λ))×10(−Ydy(λ))=10−(Cdc(λ)+Mdm(λ)+Ydy(λ)) Equation 5.

Therefore, the individual light density distribution of the arbitrary color can be approximated by equation 1.

Furthermore, according to equation 1, depending on the color difference, the individual light density curve with respect to cyan remains the shape of dc(λ) as-is and changes at a constant rate. The individual light density curves for the other layers change in the same manner.

Incidentally, when a single color light beam of wavelength λ1, intensity I1 is irradiated to an arbitrary position on the developed film, intensity I′1 of transmitted light at the position can be expressed by the following equation 6.

I′1=I1×10(−Cdc(λ1))×10(−Mdm(λ1))×10(−Ydy(λ1)) Equation 6

If both sides of equation 6 are divided by I1 and the log is taken, the following equation 7 is obtained.

−Log(I′1/I1)=Cdc(λ1)+Mdm(λ1)+Ydy(λ1) Equation 7

Furthermore, in the same manner, if intensity of transmitted light when a single color light of wavelength λ2, intensity I2 is irradiated is I′2, the following equation 8 is obtained. If intensity of transmitted light when a single color light of wavelength λ3, intensity I3 is irradiated is I′3, the following equation 9 can be obtained.

−Log(I′2/I2)=Cdc(λ2)+Mdm(λ2)+Ydy(λ2) Equation 8

−Log(I′3/I3)=Cdc(λ3)+Mdm(λ3)+Ydy(λ3) Equation 9

Equations 7, 8, and 9 which can be thus obtained can be expressed by the following equation 10.

$$[ \begin{matrix}- Log ( {I}^{′} 1 / I 1 ) \\ - Log ( {I}^{′} 2 / I 2 ) \\ - Log ( {I}^{′} 3 / I 3 )\end{matrix} ] = [ \begin{matrix}d c ( λ1 ) d m ( λ1 ) d y ( λ1 ) \\ d c ( λ2 ) d m ( λ2 ) d y ( λ2 ) \\ d c ( λ3 ) d m ( λ3 ) d y ( λ3 )\end{matrix} ] [ \begin{matrix}C \\ M \\ Y\end{matrix} ] \qquad Equation 10$$

Therefore, if an inverse matrix of the matrix of Equation 10 is multiplied by the left side, values of three parameters C, M, Y can be obtained. In Equation 10, dc(λ1), dm(λ1), . . . , dm(λ3), dy(λ3) can be calculated based on the above-mentioned functions dc(λ), dm(λ), dy(λ), and I1, I2, I3 are already-known values. That is, if I′1, I′2, I′3 can be measured, the values of the three parameters C, M, Y can be obtained, and the individual light intensity distribution can be obtained.

### EXPLANATION OF THE OPERATION OF THE FIRST EMBODIMENT

The following explains the operation of the first embodiment.

Explanation of the process which can be performed in the same manner as an already-existing film scanner is omitted here. Signal processing which is performed by the signal processor 15 when the film original 30 is scanned is explained.

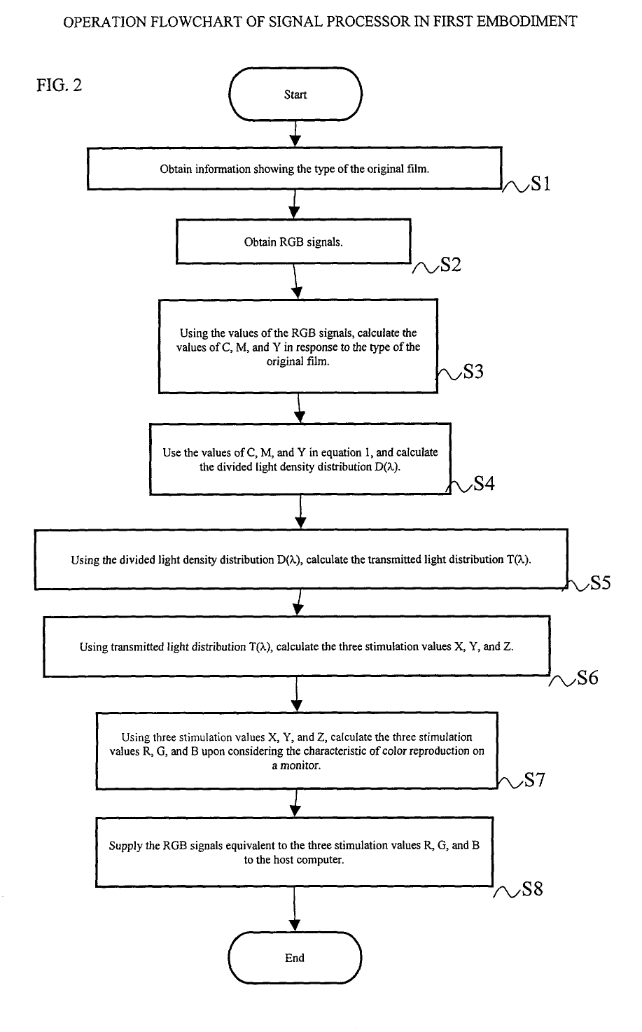

FIG. 2 is a flowchart of the operations performed by the signal processor 15 in the first embodiment.

Based on FIG. 2, the following is an explanation of signal processing which is performed by the signal processor 15.

In S1 of FIG. 2, the signal processor 15 receives information showing a type (e.g., brand) of the film original 30 designated by an operator via the keyboard 21 or the like.

In S2 of FIG. 2, the signal processor 15 receives an RGB signal which is supplied from the A/D converter 19.

In S3 of FIG. 2, the signal processor 15 uses a value of the RGB signal corresponding to each pixel of the line sensor 14. According to the type of the film original 30, the values of the three parameters of C, M, and Y are calculated.

Here, an example is shown in which the values of the three parameters C, M, and Y are calculated from the values of the RGB signals.

In equation 10 described above, an assumption is made that single color light of wavelengths λ1, λ2, and λ3 is irradiated to the film original 30. The theory of calculating values of the three parameters C, M, and Y based on equation 10 can also be applied to the case when light of the LEDs of the three colors R, G, and B is irradiated to the film original 30.

That is, I′1, I′2, and I′3 of equation 10 can be replaced with the values of the RGB signals of the respective pixels. dc(λ1), dm(λ1) . . . dm(λ3), dy(λ3) can be replaced with the density shown by the individual light density curve in the respective LED wavelength regions. However, in the case of this type of replacement, it is necessary to consider the base density of the film.

Therefore, equation 10 can be replaced with the following equation 11, and the signal processor 15 can calculate the values of the three parameters C, M, and Y from the values of the RGB signals, based on equation 11.

$$[ \begin{matrix}- Log ( R / R0 ) \\ - Log ( G / G0 ) \\ - Log ( B / B0 )\end{matrix} ] = [ \begin{matrix}d c ( r ) d m ( r ) d y ( r ) \\ d c ( g ) d m ( g ) d y ( g ) \\ d c ( b ) d m ( b ) d y ( b )\end{matrix} ] [ \begin{matrix}C \\ M \\ Y\end{matrix} ] + [ \begin{matrix}B A 1 \\ B A 2 \\ B A 3\end{matrix} ] \qquad Equation 11$$

In equation 11,

R, G, B are values of the RGB signals of the respective pixels,

R0, G0, B0 are maximum values which are allowed in the RGB signals,

dc(r)-dy(b) are densities shown by the individual light density curves in the wavelength region of the respective LEDs, and

BA1, BA2, BA3 are base densities in the wavelength regions of the respective LEDs. Values other than R, G, and B are recorded in the signal processor 15 in advance according to the type of the film original 30.

For example, the values of dc(r)-dy(b) can be obtained from the LED individual light distribution and the individual light density curve provided by a film manufacturer. BA1-BA3 can be obtained by a method of scanning a not-yet-exposed film original or the like. Furthermore, values of dc(r)-dy(b) and BA1-BA3 can be obtained by obtaining the values of C, M, and Y and the values of R, G, and B by scanning a chart including a plurality of colors, and calculating from these values such that error is minimized.

In S4 of FIG. 2, the signal processor 15 can substitute the values of the three parameters C, M, and Y which have been thus calculated into the above-mentioned equation 1 and can calculate the individual light density distribution D(λ).

In S5 of FIG. 2, the signal processor 15 converts the individual light density distribution D(λ) which was thus calculated to the individual light transmitted light distribution 10-D(λ) and calculates the transmitted light distribution T(λ) by using the individual light transmitted light distribution 10-D(λ).

For example, when color reproduction is implemented which is the same as when the film original 30 is observed using a viewer, the signal processor 15 calculates the transmitted light distribution T(λ) by calculating the following equation 12.

T(λ)=IV(λ)·10-D(λ) Equation 12

In equation 12,

IV(λ) is an individual light distribution of a light source of a viewer.

In equation 12, IV(λ) is the individual light distribution of the light source of the viewer, but any type of individual light distribution of the light source can be applied to IV(λ). Therefore, if the individual light distribution of the light source when the film original 30 is observed is applied to IV(λ), color reproduction which is the same as the case when the film original 30 is observed under the light source can be accomplished. In S6 of FIG. 2, the signal processor 15 calculates three stimulation values X, Y, and Z of an XYZ table color system by using the transmitted light distribution T(λ) which was thus calculated.

For example, the signal processor 15 calculates the three stimulation values X, Y, and Z by calculating the following equations 13-15.

X=∫x(λ)T(λ)dλ Equation 13

Y=∫y(λ)T(λ)dλ Equation 14

Z=∫z(λ)T(λ)dλ Equation 15

In equations 13-15, x(λ), y(λ), z(λ) show the equivalent color functions of CIE 1931. In S7 of FIG. 2, the signal processor 15 uses the three stimulation values X, Y, and Z of the XYZ table color system which were thus calculated and calculates the three stimulation values R, G, and B of the RGB table color system, considering the characteristic of the color reproduction on the monitor 22.

For example, the signal processor 15 calculates the three stimulation values R, G, and B by calculating the following equation 16.

$$[ \begin{matrix}R \\ G \\ B\end{matrix} ] = [ \begin{matrix}m11 & m12 & m13 \\ m21 & m22 & m23 \\ m31 & m32 & m33\end{matrix} ] [ \begin{matrix}X \\ Y \\ Z\end{matrix} ] \qquad Equation 16$$

The values of m11, . . . , m33 are determined in advance according to the characteristic of color reproduction on the monitor 22 and are recorded within the signal processor 15.

In S8 of FIG. 2, the signal processor 15 supplies the RGB signal equivalent to the three stimulation values R, G, and B of the RGB table color system calculated as described above to the host computer 20 via the interface 16.

Thus, the RGB signal supplied to the host computer 20 is displayed on the monitor 22.

As explained above, in the film scanner of the first embodiment, by using the value of the RGB signal corresponding to each pixel of the line sensor 14, the individual light density distribution corresponding to the respective pixels can be calculated. Furthermore, based on the individual light density distributions, the three stimulation values R, G, and B of the RGB table color system can be calculated, considering the characteristics of color reproduction on the monitor 22.

That is, in the film scanner of the first embodiment, colorimetry of the chart is not needed, so regardless of whether a color exists in the chart, various colors can be accurately reproduced.

In particular, when colors slightly change between the adjacent pixels, in a conventional film scanner, color continuity is lost because of an interpolation method or the like. On the contrary, in the film scanner of the first embodiment, color reproduction can be accomplished while continuity between pixels is maintained.

Furthermore, in the film scanner of the first embodiment, preparation of the chart having a plurality of colors, colorimetry for the chart, and the like are not needed.

Additionally, in the first embodiment, three colors of R, G, and B of LEDs are used as a light source, so the value of the three parameters C, M, and Y are calculated based on equation 11. However, for example, when six colors of LEDs are used as the light source 17, the values of the three parameters C, M, and Y can be calculated from the values obtained by substituting the respective LED light wavelengths λ1-λ6 into Equation 1, described above, such that error is minimized.

Furthermore, in the first embodiment, because the monitor 22 is used as an output device, the RGB signal is supplied to the host computer 20. However, for example, when a printer is used as an output device, the three stimulation values X, Y, and Z calculated by equations 13-15 may be converted to brightness index L*and perception chromaticity a*, b* of an L*a*b*color table system, or to brightness index L* and perception chromaticity u*, v* of an L*u*v table color system, a CMY signal may be generated, and the generated CMY signal may be supplied to the host computer 20.

### EXPLANATION OF THE OPERATION OF THE SECOND EMBODIMENT

The following explains an operation of the second embodiment.

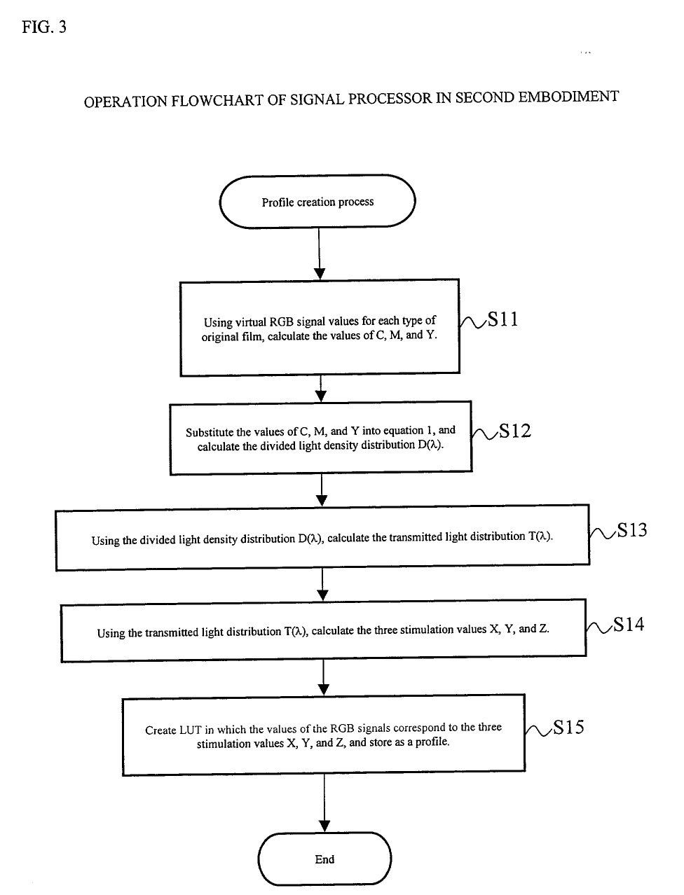

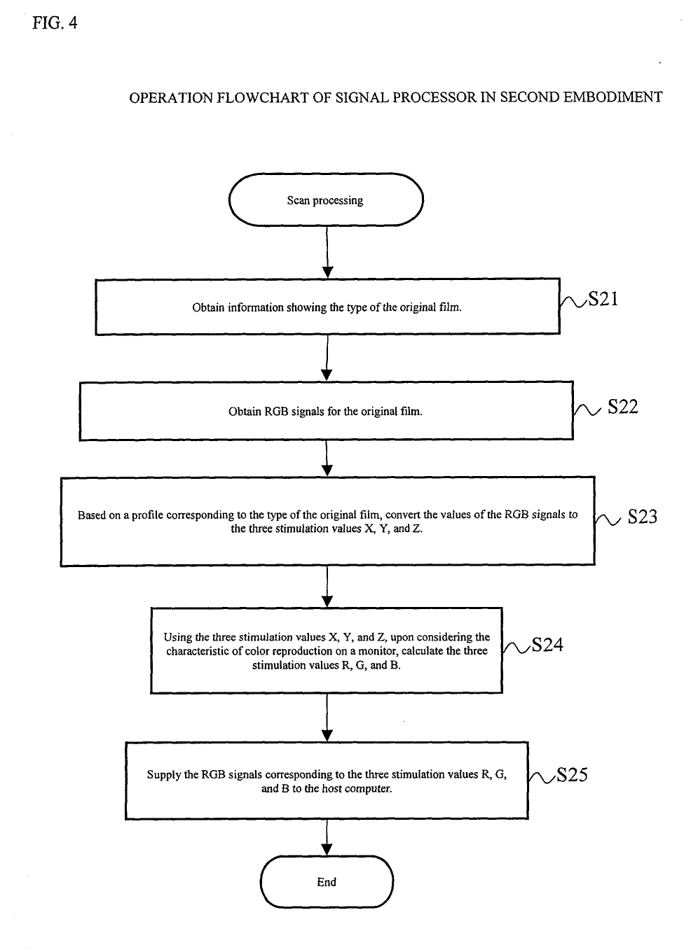

FIGS. 3 and 4 are operation flowcharts of the signal processor 15 in the second embodiment. In particular, FIG. 3 shows a process (hereafter referred to as “profile creation process”) which creates a profile that is referred to when the film original 30 is scanned. FIG. 4 shows a process (hereafter referred to as “scan process”) used when the film original 30 is scanned.

First, based on FIG. 3, the “profile creation process” in the signal processor 15 is explained.

In S11 of FIG. 3, the signal processor 15 calculates the values of three parameters C, M, and Y in the same manner as in the process of S3 of FIG. 2 of the first embodiment by using the respective values of a plurality of versions of virtual RGB signals for the respective types of the film original 30 which can be subjected to the scan process.

For example, when a profile which can be applied to 32,000 colors is created, the signal processor 15 can calculate the values of the three parameters C, M, and Y by using the respective values of 32,000 versions of virtual RGB signals.

In S12 of FIG. 3, in the same manner as in the process of S4 of FIG. 2 of the first embodiment, the signal processor 15 substitutes the values of the three parameters C, M, and Y and the values of dc(r)-dy(b) (densities shown by the individual light density curves in the respective LED wavelength regions) into Equation 1 and calculates the individual light density distribution D(λ).

In S13 of FIG. 3, the signal processor 15 calculates the transmitted light distribution T(λ) by using the individual light density distribution D(λ) in the same manner as in the process of S5 of FIG. 2 of the first embodiment.

In S14 of FIG. 3, the signal processor 15 calculates the three stimulation values X, Y, and Z of the XYZ table color system by using the transmitted light distribution T(λ) in the same manner as in the process of S6 of FIG. 2 of the first embodiment..

In S15 of FIG. 3, the signal processor 15 creates a LUT corresponding to the three stimulation values X, Y, and Z and the respective values of a plurality of versions of virtual RGB signals, and stores this as a profile.

Next, based on FIG. 4, the “scan process” in the signal processor 15 is explained.

In S21 of FIG. 4, the signal processor 15 obtains information showing the type of the film original 30 in the same manner as in the process of S1 of FIG. 2 of the first embodiment.

In S22 of FIG. 4, the signal processor 15 obtains the RGB signal corresponding to the film original 30 supplied from the A/D converter 19.

In S23 of FIG. 4, the signal processor 15 converts the values of the RGB signals to the three stimulation values X, Y, and Z of the XYZ table color system, based on the profile corresponding to the type of the film original 30.

In S24 of FIG. 4, in the same manner as in the process of S6 of FIG. 2 of the first embodiment, the signal processor 15 calculates the three stimulation values R, G, and B of the RGB table color system, considering the characteristic of color reproduction on the monitor 22, by using the three stimulation values X, Y, and Z of the XYZ table color system.

In S25 of FIG. 4, in the same manner as in the process of S7 of FIG. 2 of the first embodiment, the signal processor 15 supplies the RGB signals equivalent to the three stimulation values R, G, and B of the RGB table color system to the host computer 20 via the interface 16.

The RGB signals which were thus supplied to the host computer 20 is displayed on the monitor 22.

As explained above, in the second embodiment, without performing colorimetry of the chart, a profile corresponding to the type of the film original 30 which can be subjected to the scan process is created. Because of this, in the film scanner of the second embodiment, different from a conventional film scanner in which the LUT was created based on colorimetry of the chart, the value which was predicted by an interpolation method or the like does not need to be performed regardless of the number of colors.

Therefore, according to the second embodiment, a profile with high accuracy can be easily created, and color reproduction can be accomplished more accurately than in a conventional film scanner.

Furthermore, in the second embodiment, in order to convert the RGB signals to the three stimulation values X, Y, and Z during scan processing, the LUT showing correlation of the RGB signals and the three stimulation values X, Y, and Z is created as a profile. However, it is also acceptable to, as a profile, according to the content of conversion during the scan processing, create a LUT showing correlation of the RGB signal to the brightness index L* and perception chromaticity a*, b* of an L*a*b* table color system, or an LUT showing correlation of the RGB signals to the brightness index L* and perception chromaticity u*, v* of an L*u*v table color system.

Additionally, in the above-mentioned respective embodiments, the type of the film original 30 is designated by an operator via the keyboard 21. However, for example, when information showing the type is recorded on the film original 30, by setting the function which reads the information in the film scanner 10, the information showing the type of the film original 30 can be obtained.

Furthermore, in the above-mentioned respective embodiments, the process shown in FIGS. 2, 3 and 4 is accomplished by the signal processor 15. However, by using a recording medium (e.g., CD-ROM or the like) in which the program equivalent to the process by this type of signal processor 15 is recorded and installing the program in the host computer 20 in advance, the process shown in FIGS. 2, 3, and 4 can also be accomplished in the host computer 20.

Incidentally, in the above-mentioned respective embodiments, an example is shown in which the individual light density distribution is calculated from the values of the RGB signals corresponding to the respective pixels of the line sensor 14, as the individual light density distribution D(λ) of an arbitrary color is approximated as shown by equation 1. Here, an example is shown in which the individual light density distribution is more accurately calculated.

According to equation 1, regardless of color differences, the individual light density curves for the respective layers maintain a constant shape (the above-mentioned dc(λ), dm(λ), and dy(λ) shapes). However, the individual light density curves for the respective layers actually have a slightly different shape depending on the color difference.

Therefore, an example is shown here in which the film original in which the densities of the respective layers gradually change is individually color-measured, individual light density curves with different shapes for the respective layers are prepared in advance, and the individual light density curves which are used when the individual light density distribution of an arbitrary color is calculated are obtained by interpolation.

For example, the individual light density curves obtained when a film original in which the densities of the respective layers change in k steps are individually color measured for each light are expressed as:

dc1(λ), dc2(λ), . . . , dck(λ),

dm1(λ), dm2(λ), . . . , dmk(λ),

dy1(λ), dy2(λ), . . . , dyk(λ)

If the individual light density curves obtained by interpolation from the individual light density curves are dcx(λ), dmx(λ), and dyx(λ), the individual light density distribution D(λ) of an arbitrary color can be shown by the following equation 100.

D(λ)=dcx(λ)+dmx(λ)+dyx(λ) Equation 100

Furthermore, the relationship between the maximum value of the density shown by the above-mentioned respective individual light density curves and the values of the RGB signals can be shown by the characteristics of the respective individual light density curves and the individual light characteristics of the LEDs.

Therefore, if the parameters showing the maximum value of the densities in the respective layers of the film original 30 are C, M, Y and polynominal equations formed of these parameters are f1 . . . , f9, the following system of equations can be established.

$$\{ \begin{matrix}- Log ( R / R0 ) = f1 ( C ) + f2 ( M ) + f3 ( Y ) + B A 1 \\ - Log ( G / G0 ) = f4 ( C ) + f5 ( M ) + f6 ( Y ) + B A 2 \\ - Log ( B / B0 ) = f7 ( C ) + f8 ( M ) + f9 ( Y ) + B A 3\end{matrix} \qquad Equation 101$$

In equation 101,

R, G, B are the value of the RGB signals of the respective pixels,

R0, G0, B0 are the maximum values allowed in the RGB signals, and

BA1, BA2, BA3 are the base densities in the respective LED wavelength regions.

If this type of equation system is solved for C, M, and Y, then C, M, and Y are shown by functions in which the values of R, G, and B are variables.

Therefore, if this type of function is prepared in advance, the signal processor 15 can calculate a more accurate individual light density distribution D(λ) by performing the following process 1 and process 2 instead of the processes S2 and S3 of FIG. 2 or the processes S11 and S12 of FIG. 3.

Process 1: By using the above-mentioned functions (functions of C, M, and Y in which the values of R, G, B are variables), the value of the three parameter C, M, and Y are calculated from the values of the RGB signals.

Process 2: Based on the values of the three parameters C, M, and Y, dcx(λ), dmx(λ), and dyx(λ) are obtained by interpolation from the individual light density curves of the respective layers prepared in advance, and by substituting dcx(λ), dmx(λ), and dyx(λ) which were thus obtained into equation 100, the individual light density distribution D(λ) is calculated.

In this invention which was thus explained, based on the density characteristic of the transparent film original, the individual light density distribution for a color resolution signal read by an imaging means can be obtained. Because of this, a state of a color of the film original can be accurately obtained. The density characteristic which is used in a process in which the individual light density distribution is calculated is changed according to the type of transparent film original, so the state of the color of the film original can be further accurately obtained.

What is claimed is:

1. An image reading apparatus including imaging means for reading a color image of a transparent film original to output color resolution signals of a plurality of colors, comprising:
individual light density distribution calculation means for calculating individual light density distributions of the transparent film original from density characteristics of the transparent original film and the color resolution signals output by the imaging means.

2. The image reading apparatus as set forth in claim 1, wherein:
the density characteristics are individual light density curves of the transparent film original with respect to a predetermined color; and
the individual light density distribution calculation means obtains the density characteristics in advance and, when the color resolution signals are output by the imaging means, converts the color resolution signals to density equivalent values, obtains a value of a parameter showing the density of the transparent film original by linear conversion of the density equivalent values according to the density characteristics, and calculates the individual light density distributions of the transparent film original from the value of the parameter.

3. The image reading apparatus as set forth in claim 1, wherein:
the density characteristics are individual light density curves of the transparent film original with respect to a plurality of predetermined colors; and
the individual light density distribution calculation means obtains the density characteristic in advance by performing colorimetry of the plurality of predetermined colors, correlates values of the color resolution signals readable by the imaging means to a value of a parameter showing a density of the transparent film original according to the density characteristics, and when the color resolution signals are output by the imaging means, obtains a value of the parameter from the color resolution signals based on the correlation, and calculates the individual light density distributions of the transparent film original from the value of the parameter.

4. The image reading apparatus as set forth in any of claims 1-3, wherein the individual light density distribution calculation means changes the density characteristics which are used in the process of calculating the individual light density distributions according to a type of the transparent film original.

5. The image reading apparatus as set forth in claim 4, further comprising:
type obtaining means for obtaining the type of the transparent film original read by the imaging means.

6. The image reading apparatus as set forth in any of claims 1-5, further comprising:
transmitted light distribution calculation means for converting the individual light density distributions calculated by the individual light density distribution calculation means to individual light transmissivity distributions, and for calculating transmitted light distributions of the transparent film original from individual light distributions of a predetermined light source and the individual light transmissivity distributions.

7. The image reading apparatus as set forth in claim 6, further comprising:
table color system conversion means for calculating values of a predetermined table color system from the transmitted light distributions calculated by the transmitted light distribution calculation means.

8. An image reading apparatus including imaging means for reading a color image of a transparent film original to output color resolution signals of a plurality of colors, comprising:
table creation means for creating a table showing a correlation between values of a predetermined table color system and color resolution signals readable by the imaging means; and
table color system conversion means for converting the color resolution signals output by the imaging means to values of a predetermined table color system based on the table;
wherein, from density characteristics of the transparent film original and a plurality of versions of virtual color resolution signals readable by the imaging means, the table creation means calculates an individual light density distribution for each virtual color resolution signal, calculates values of a predetermined table color system from the individual light density distributions, and creates the table.

9. The image reading apparatus as set forth in claim 8, wherein:
the density characteristics are individual light density curves of the transparent film original with respect to a predetermined color; and
the table creation means obtains the density characteristics, converts each virtual color resolution signal to a density equivalent value, obtains a value of a parameter showing a density of the transparent film original by linear conversion of the density equivalent values according to the density characteristics, and calculates the individual light density distribution with respect to each virtual color resolution signal from a value of the parameter.

10. The image reading apparatus as set forth in claim 8, wherein:
the density characteristics are individual light density curves of the transparent film original with respect to a plurality of predetermined colors; and
the table creation means obtains the density characteristics by performing colorimetry of the plurality of predetermined colors, correlates values of the color resolution signals readable by the imaging means to a value of a parameter showing a density of the transparent film original, obtains a value of a parameter, based on the correlation, from a value of each virtual color resolution signal, and calculates the individual light density distribution with respect to each of the virtual color resolution signals from the value of the parameters.

11. The image reading apparatus as set forth in any of claims 8-10, wherein the table creation means changes the density characteristics which are used in the process of calculating the individual light density distributions for each virtual color resolution signal according to a type of the transparent film original.

12. The image reading apparatus as set forth in any of claims 8-11, wherein the table creation means converts the individual light density distributions to individual light transmissivity distributions, calculates transmitted light distributions from individual light distributions of a predetermined light source and the individual light transmissivity distributions, and calculates values of a predetermined table color system from the transmitted light distribution.

13. A program which performs signal processing by a computer with respect to color resolution signals of a plurality of colors read by an image reading apparatus having imaging means for reading a color image of a transparent film original to output color resolution signals of a plurality of colors, comprising:
an individual light density distribution calculation procedure which calculates individual light density distributions of the transparent film original from density characteristics of the transparent film original and the color resolution signals output by the imaging means.

14. A program which performs signal processing by a computer with respect to color resolution signals of a plurality of colors read by an image reading apparatus having imaging means for reading a color image of a transparent film original to output color resolution signals of a plurality of colors, comprising:
a table creation procedure which creates a table showing correlation between values of a predetermined table color system and color resolution signals read by the imaging means; and
a table color system conversion procedure which converts the color resolution signals read by the imaging means to values of a predetermined table color system based on the table;
wherein, from density characteristics of the transparent film original and a plurality of versions of virtual color resolution signals readable by the imaging means, the table creation procedure calculates an individual light density distribution for each virtual color resolution signal, calculates values of a predetermined table color system from the individual light density distributions, and creates the table.

15. A recording medium, readable by a computer, which stores a program that performs signal processing by the computer with respect to color resolution signals of a plurality of colors read by an image reading apparatus having imaging means for reading a color image of a transparent film original to output color resolution signals of a plurality of colors, comprising:
an individual light density distribution calculation procedure which calculates individual light density distributions of the transparent film original from density characteristics of the transparent film original and the color resolution signals read by the imaging means.

16. A recording medium, readable by a computer, which stores a program that performs signal processing by the computer with respect to color resolution signals of a plurality of colors read by an image reading apparatus having imaging means for reading a color image of a transparent film original to output color resolution signals of a plurality of colors, comprising:
a table creation procedure which creates a table showing correlation between values of a predetermined table color system and color resolution signals read by the imaging means; and
a table color system conversion procedure which converts the color resolution signals read by the imaging means to values of a predetermined table color system based on the table;
wherein, from density characteristics of the transparent film original and a plurality of versions of virtual color resolution signals readable by the imaging means, the table creation procedure calculates an individual light density distribution for each virtual color resolution signal, calculates values of a predetermined table color system from the individual light density distributions, and creates the table.
